(19) United States
(12) Patent Application Publication
(10) Pub. No.: US 2007/0044628 A1
(43) Pub. Date: Mar. 1, 2007

(54) Rear pivot pusher for a food slicer with clearance position

(76) Inventors: Scott J. Rote, New Lenox, IL (US); Todd L. Clem, Goshen, IN (US); James W. Robinson, Mundelein, IL (US)

Correspondence Address: Mark W. Croll;Illinois Tool Works Inc., 3600 West Lake Avenue, Glenview, IL, 60026, US

(21) Appl. No.: 11/348,704

(22) Filed: Feb. 7, 2006

Related U.S. Application Data
(60) Provisional application No. 60/711,765, filed on Aug. 26, 2005.

(51) Int. Cl. B26D 7/06

(52) U.S. Cl. 83/717

(57) ABSTRACT

A food slicer is provided having a support member including a base portion and an upstanding portion integrally formed with the base portion. The upstanding portion includes a rotating cutting blade secured thereto for slicing food product and at least one motor positioned within the upstanding portion for rotating the cutting blade. The base portion includes a food product table slidably secured thereto and is movable across the cutting blade for holding product while it is being sliced by the cutting blade. An adjustable gage plate also is provided for determining the thickness of a food product to be sliced by the cutting blade. A pusher for engagement with the food product during slicing is included where the pusher is secured to the food product table and is capable of being rotated toward a front end of the food product table to a position beneath the food product table for accommodating longer food product while enabling easier access by an operator.

### CROSS-REFERENCE TO RELATED APPLICATIONS

This application claims benefit of U.S. provisional patent application Ser. No. 60/711,765, filed Aug. 26, 2005, which is herein incorporated by reference.

### TECHNICAL FIELD

The present invention relates generally to food slicers and more particularly to a new design for a pusher for a food slicer that provides for an enhanced sanitary environment, enables easier operation and cleaning and incorporates a number of enhanced ergonomic features.

### BACKGROUND

The basic design of both manual and automatic food slicers has proven to be quite effective and durable throughout the years. Although various important improvements have been made to such slicers, the overall design has not changed very much particularly with regard to the overall cleanliness, ergonomics, or ease of operation.

Today, food slicers are utilized to slice a number of food products such as meats, cheeses and the like in a variety of environments such as delicatessens, supermarkets, and restaurants to name a few. Such food slicers need to be quite durable since they tend to be used for many hours during a day by many different individuals while providing the desired performance, safety and cleanliness.

Additionally, food slicers need to be designed to allow adaptability since they need to handle a variety of products of different shapes, sizes, and textures while readily providing slices of different thicknesses of the product being sliced. The speed at which a particular product is moved across the cutting blade can also vary on automatic food slicers to improve productivity.

Gravity food slicers with reciprocating food product tables have a feature called a “pusher” that engages the food product on its top surface or end opposite the blade to assist in holding the food product and increase its stability during slicing and movement of the food product table. Pushers typically are mounted on the front edge of the food product table closest to the operator or the rear edge of the table farthest away from the operator and generally rotate about an axis and translate along the axis.

When a long piece of food product is to be sliced (such as a long salami or the like) pushers mounted on the rear of the food product table sometimes permit the operator to rotate the pusher out of the way of the long food product. These rear mounted pushers are rotated clockwise behind the food product table to dangle behind the table on the rear or right end when viewed from the right hand side of the food slicer. In this position, they can inadvertently contact the table or the support arm for the table when the table is moved. Moreover, this position makes it hard for the operator to reach to rotate the pusher back into position.

### SUMMARY

In accordance with an embodiment, a food slicer is provided having a support member including a base portion and an upstanding portion integrally formed with the base portion. The upstanding portion includes a rotating cutting blade secured thereto for slicing food product and at least one motor positioned within the upstanding portion for rotating the cutting blade.

The base portion includes a food product table slidably secured thereto and is movable across the cutting blade for holding product while it is being sliced by the cutting blade. An adjustable gage plate also is provided for determining the thickness of a food product to be sliced by the cutting blade.

A pusher for engagement with the food product during slicing is included where the pusher is secured to the food product table and capable of being rotated toward a front end of the food product table to a position beneath the food product table for accommodating longer food product while enabling easier access by an operator.

### BRIEF DESCRIPTION OF THE DRAWINGS

The present disclosure will become better understood with reference to the following description and accompanying drawings, wherein:

FIG. 1 is a top right perspective view of a food slicer according to one embodiment of the present invention;

FIG. 2 is a front plan view of the food slicer of FIG. 1;

FIG. 3 is a top right perspective view of a pusher and food product table of the food slicer of FIGS. 1 and 2;

FIG. 4 is an exploded perspective view of the pusher and food product table of FIGS. 1-3;

FIG. 5 is a bottom perspective view of the pusher and food product table of FIGS. 1-4; and

FIG. 6 is a top perspective view of the pusher and food product table of FIGS. 1-4 generally illustrating the pusher rotated to a position beneath the food product table.

### DETAILED DESCRIPTION

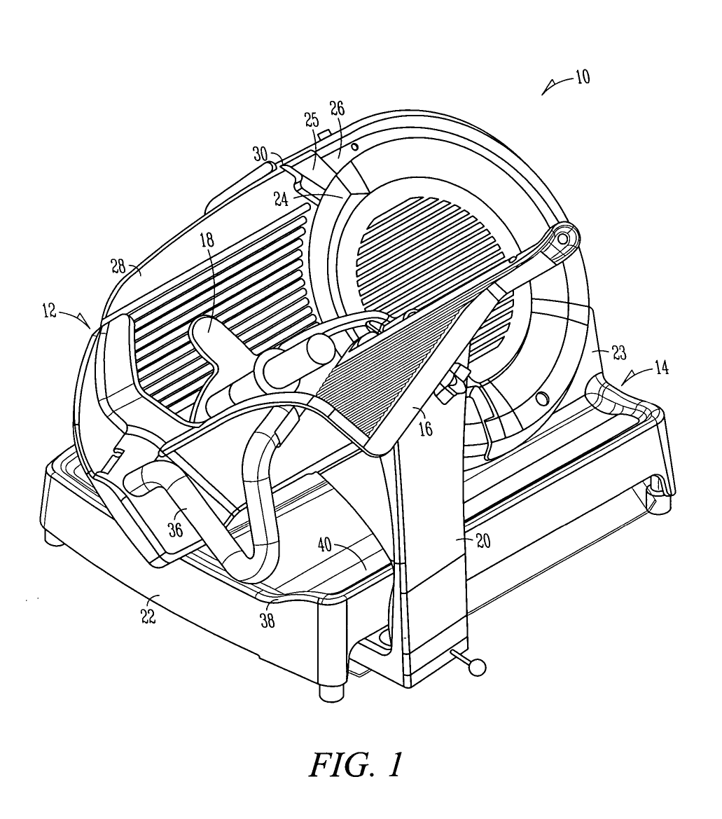

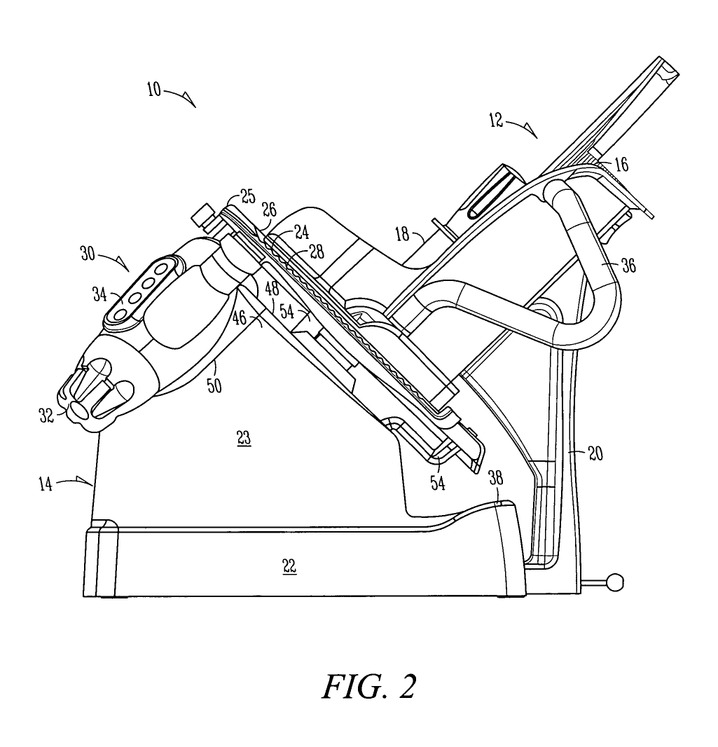

The food slicer of the present invention is generally illustrated by numeral 10 of FIGS. 1-2 wherein like parts are designated by like reference numerals. Although the present disclosure will be described with reference to the example embodiments illustrated in the figures, it should be understood that the food slicer 10 may have many alternative forms without departing from the teachings of the present invention. One of ordinary skill in the art will additionally appreciate different ways to alter the parameters of the embodiments disclosed, such as the size, shape, or type of elements or materials, in a manner that falls within the spirit and scope of the present disclosure and appended claims.

FIGS. 1 and 2 illustrate the basic components of the food slicer 10 of the present invention. The food slicer 10 substantially includes a food handling portion generally illustrated by reference numeral 12 and a support portion, housing or member generally illustrated by reference numeral 14.

The food handling portion 12 substantially includes a product table 16, a push arm or pusher 18 and a product table support arm 20. The support portion 14 substantially includes a base portion or member 22, an upstanding portion or member 23, a rotating circular slicing knife or cutting blade 24, a ring guard 25, a knife cover 26, an adjustable gage plate 28 for determining slicing thickness and a control member or operator interface 30 having a gage plate support and adjustment mechanism 32 for the gage plate 28 and control buttons 34 as illustrated in FIG. 2.

The support portion 14 also includes at least one motor (not illustrated) positioned within the inside of the upstanding portion 23. If desired, a second motor (not illustrated) may be positioned within the inside of the support portion 14 along with associated structure for automatically moving the product table 16.

Briefly, for manual slicing, a food product (not illustrated) is placed on the product table 16 beneath the pusher 18 with the end to be cut or sliced resting upon the gage plate 28 with the product table 16 in its forward position. The operator adjusts the gage plate adjustment mechanism 32 which directly moves the gage plate 28 with respect to the blade 24 to provide a slice thickness gap therebetween that corresponds to the desired thickness for slicing of the product and gets bigger with thicker slices. The control buttons 34 are then accessed to turn the motor on which in turn rotates the blade 24.

The operator then pushes the product table 16 preferably via a handle 36 or other contact point forward or to the right with respect to FIG. 1 whereby the blade 24 slices the product to the desired thickness. The operator then pulls the product table 16 backward or to the left with respect to FIG. 1 for continued slicing of the product as described above.

FIGS. 1, 3 and 4 generally illustrate one embodiment of the pusher 18. The pusher 18 is generally designed to assist in holding food product (not illustrated) on the food product table 16 during slicing where the weight of the pusher 18 and gravity assist in holding the food product. The pusher 18 also helps to urge the food product toward the gage plate 28.

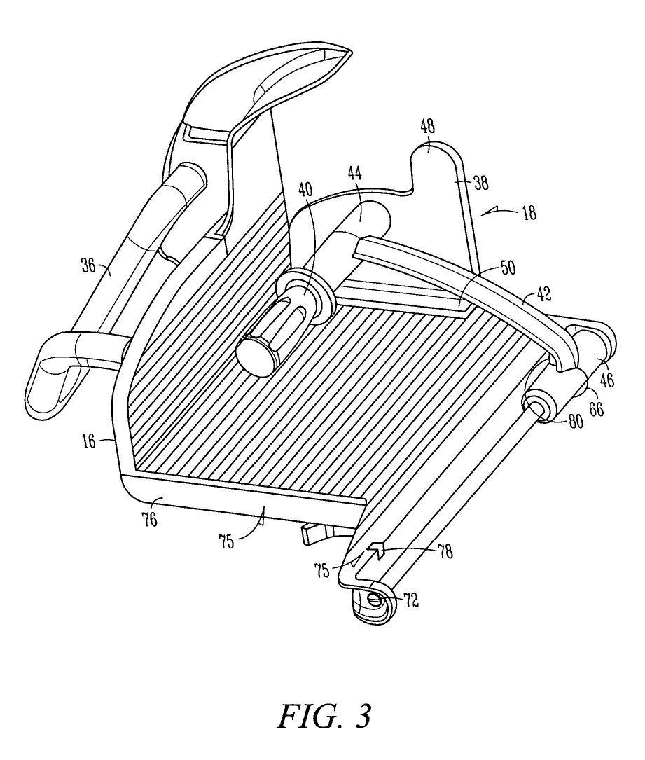

The pusher 18 substantially includes a food engagement portion 38, handle 40 and support arm 42 having a first end 44 having an aperture 45 for the handle 40 to extend therethrough and an a second opposite end 46 also having an aperture or throughbore for securing to the food product table 16 as will be described in detail below. As FIG. 3 illustrates, the food engagement portion 38 is shaped to accommodate most food products and includes a food engagement surface 48 and an integrally formed lip 50 for engagement with a top surface of the food product if desired.

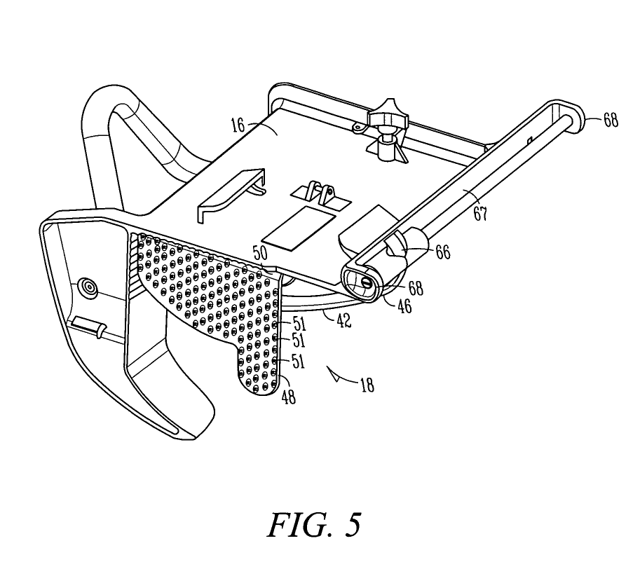

As FIG. 5 illustrates, both the engagement surface 48 and lip 50 may include one or more upstanding pins or barbs 51 for engagement with the food product. It is to be understood, however, that the particular size, shape and material of the pusher 18 can vary.

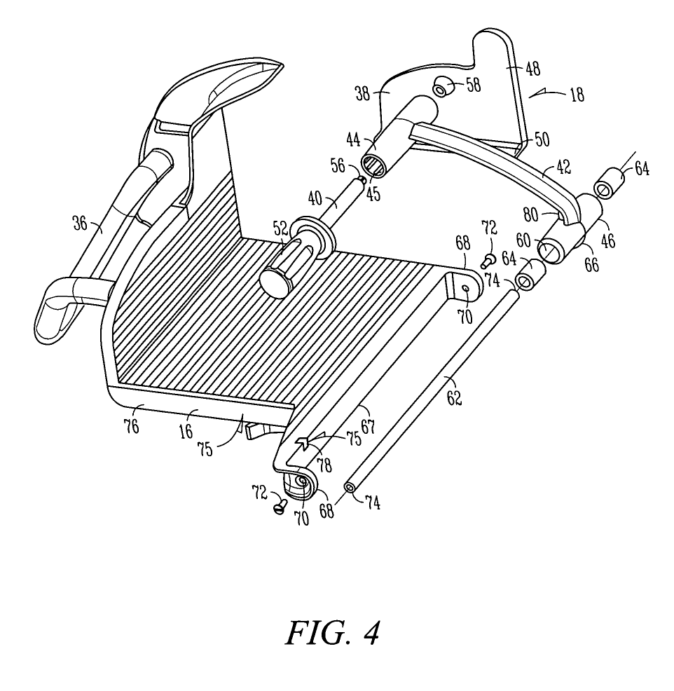

As FIG. 4 illustrates, the handle 40 includes a grip portion 52 and a shaft 54 which is threaded at one end 56 for threaded engagement with a nut 58 molded into the back side of the engagement surface 48 of the engagement portion 38. The engagement portion 38 preferably is molded with a food contact grade of glass reinforced nylon, but the particular material can vary. The nut 58 is captured in the engagement portion 38 during the injection molding process. To assemble the handle 40 to the engagement surface 48 and support arm 42, the shaft 54 is inserted through the aperture 45 in the first end 44 of the support arm 42 and screwed into the nut 58. It is to be noted that with this design of the pusher 18 the shaft 54 of the grip 52 is rotatable within the first end 44 of the support arm 42 and when turned rotates the engagement surface 48 and lip 50 to accommodate different positions and food products.

The grip portion 52 preferably is molded with a food contact grade of glass reinforced nylon and is overmolded onto the shaft 54 on the end of the shaft 54 opposite the threads 56. The shaft 54 preferably is formed from metal, such as stainless steel. The particular design, materials and attachment of the grip portion 52 and shaft 54, however, can vary.

The second end 46 of the support arm 42 is formed with a throughbore 60 for securing to a pusher guide bar 62 and provides rotation of the support arm 42 about the guide bar 62 as well as translational movement along the length of the guide bar 62. Bushings 64 can be provided to assist in providing the desired rotational and translational movement between the support arm 42 and guide bar 62 that preferably is formed from stainless steel, but can vary.

As FIGS. 4 and 5 illustrate, to restrict movement of the pusher 18 clockwise behind the product table 16 as viewed from the right, the second end 46 of the support arm 42 includes a strut 66. When assembled, the strut 66 engages with an edge 67 of the product table 16 and only allows rotation of the pusher 18 to a substantially vertical position with respect to the product table 16 and prohibits further clockwise rotation behind the product table 16 when viewed as in FIG. 4.

As FIG. 4 illustrates, to secure the guide bar 62, and hence pusher 18, to the rear end of the product table 16 as desired, the product table 16 includes two brackets 68, one on either side of the product table 16. The brackets 68 include apertures 70 through which screws 72 extend to engage with threaded bores 74 on either end of the guide bar 62.

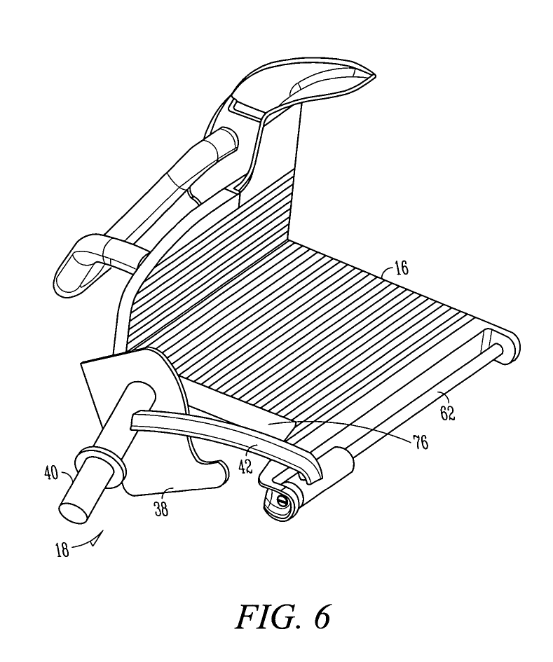

As FIGS. 3 and 4 illustrate, the product table 16 includes a pusher arm parking feature generally designated by reference numeral 75. The product table 16 includes an end 76 generally formed in the shape of an “L” on the right side of the food product table 16 and slicer 10. When the pusher 18 is slid along the guide bar 62 toward the end 76 of the product table 16, it is capable of rotating generally counterclockwise or downward to a parked position beneath the food product table 16 as shown in FIG. 6.

In the parked position, the food engagement portion 38 is rotated to a desired position so that the pusher 18 is beneath the product table 16 to allow long food product to extend beyond the end 76 of the product table 16. After slicing the long product, the parking feature enables easy access by an operator to the pusher 18 since the pusher slides to the right end of the slicer 10 and rotates forward and generally facing an operator without falling behind the food product table 16.

To limit counterclockwise or downward rotation of the pusher 18 and maintain or hold the pusher 18 in this position during slicing, the support arm 42 engages with a portion of the end 76 of the food product table 16. To further assist in maintaining or holding the pusher 18 in this position during slicing and prevent the pusher 18 from sliding along the guide bar 62, the food product table includes a notch 78 within which a corresponding edge 80 of the support arm 42 seats (see FIGS. 3 and 4). The particular design and materials used to maintain the pusher 18 in position beneath the food product table 16 during slicing, however, can vary.

Numerous modifications and alternative embodiments of the present disclosure will be apparent to those skilled in the art in view of the foregoing description. Accordingly, this description is to be construed as illustrative only and is for the purpose of teaching those skilled in the art the best mode for carrying out the present disclosure. Details of the structure may vary substantially without departing from the spirit of the present disclosure, and exclusive use of all modifications that come within the scope of the appended claims is reserved. It is intended that the present disclosure be limited only to the extent required by the appended claims and the applicable rules of law.

What is claimed is:

1. A food slicer, comprising:
a support member having a base portion and an upstanding portion integrally formed with said base portion;
a rotating cutting blade secured to said upstanding portion for slicing food product;
at least one motor positioned within said upstanding portion for rotating said cutting blade;
a food product table slidably secured to said base portion and movable across said cutting blade for holding product while being sliced by said cutting blade;
an adjustable gage plate for determining the thickness of a food product to be sliced by said cutting blade; and
a pusher for engagement with the food product during slicing, said pusher being rotatably secured to said food product table and capable of moving toward a front end of said food product table to a position beneath said food product table for accommodating longer food product.

2. The food slicer as defined in claim 1, wherein said pusher is secured to a rear end of said food product table.

3. The food slicer as defined in claim 1, wherein said pusher is secured to said food product table for both rotational and translational movement with respect to said food product table to a position beneath said food product table.

4. The food slicer as defined in claim 1, including means for maintaining said pusher in position beneath said food product table during slicing.

5. A pusher for a food slicer, comprising:
a handle for access by an operator;
a food product engagement portion secured to said handle; and
an attachment member for rotatably securing the pusher to a food product table of the slicer, the attachment member being capable of providing movement of the pusher toward a front end of the food product table to a position beneath the food product table for accommodating longer food product.

6. The pusher as defined in claim 5, wherein the pusher is secured to a rear end of said food product table.

7. The pusher as defined in claim 5, wherein the pusher is secured to said food product table for both rotational and translational movement with respect to said food product table to a position beneath said food product table.

8. The pusher as defined in claim 5, including means for maintaining said pusher in position beneath said food product table during slicing.

9. The pusher as defined in claim 5, wherein said handle is overmolded onto a shaft member for attachment to said food product engagement portion.
